(19) United States
(12) Patent Application Publication
(10) Pub. No.: US 2015/0258850 A1
(43) Pub. Date: Sep. 17, 2015

(54) SHIELDED HOSPITAL CASTER

(71) Applicant: Roberto Nicola SCHIOPPA, São Paulo (BR)

(72) Inventor: Roberto Nicola SCHIOPPA, São Paulo (BR)

(21) Appl. No.: 14/580,881

(22) Filed: Dec. 23, 2014

(30) Foreign Application Priority Data
Mar. 12, 2014 (BR) 10 2014 005702 1

(51) Int. Cl. B60B 33/02; B60B 33/00

(52) U.S. Cl. CPC B60B 33/021; B60B 33/0065; B60B 33/023; B60B 33/0086

(57) ABSTRACT

A shielded hospital caster has a structural framework which sustains the solid steel axle and nut for mounting on furniture, a rolling axle, on which wheels are mounted, each wheel having an intermediary part having gear segments on a side facing the framework. The wheels are fixed to the framework through nuts and sealed externally through hubs. In one version, the caster has a device mounted at the lower base of the framework and comprising a moving body activated by a brake pedal. The device controls locking or release of rotation in the vertical axle itself through engagement of the head of the moving body on a toothed track of the caster and controls locking or release in the rolling direction by engagement of teeth of lateral flaps the moving body with the gear segments of the wheels. In the second version, the device is formed by a fixed body.

### CROSS REFERENCE TO RELATED APPLICATIONS

Applicant claims priority under 35 U.S.C. §119 of Brazilian Patent Application No. 10 2014 005 702.1 filed on Mar. 12, 2014, the disclosure of which is incorporated by reference.

### BACKGROUND OF THE INVENTION

This invention concerns improvements introduced in hospital caster whose constructive characteristics consist of an innovated shielded caster especially developed to put together furniture and equipment that require maximum safety in relation to dirtiness, for example, of the kind used in hospitals, clinics, among others, these furniture such as, stretchers, beds, armchairs, closets, tables, etc.

It is common knowledge that hygiene in hospital environment and the like, aside from providing comfort, physical and mental well-being, is essential for controlling infections, preventing the spreading of diseases to patients, mainly for being more sensitive or vulnerable to contact of any virus or bacteria.

Generally, the areas that remain dusty, moist or wet, whether outdoors or indoors, in their totality host germs and/or facilitate their reproduction. Thus, the presence of dirt on the ground is easily transferred to countless objects, furniture and equipment existing in hospital environments, which begin to act, passively, as transmitting means of these agents to all patients and other inhabitants of these environments.

Hospital cleanliness, in a general way, consists of cleaning and conservation of environments and disinfection of fixed and/or moving surfaces, such as, stretchers, beds, armchairs, closets, table, among others, so as to promote the removal of dirt, mainly, the removal, reduction or destruction of microorganisms, through application of chemical, mechanical or thermal energies during determined period of time, on surfaces of different hospital areas, aside from manual cleaning performed frequently by professional cleaners.

Checking the history of this type of cleaning, one of the main dirt transferring vehicles from one site to another consists of the use of casters, usually used on hospital furniture and equipment, whose constructive characteristics, as a general rule, do not present adequate shielding or enclosure that prevent contamination of their internal parts, promoting accumulation of dirt that are not adequately cleaned by those responsible for cleaning, since rags or brushes are not able to reach the internal parts, such as axles, covers, etc.

The applicant, acting in the manufacturing field of casters destined to facilitate the displacement of furniture is already in possession of patent document no. PI 0701644-1 published on Feb. 26, 2008 which deals with a rotating caster that bears, in its bulge, a pulley blocking system, formed by a pedal with a lever whose intermediate part presents gear segments positioned beside the ends of the intermediary casing, and which interact along with the teeth of the lock ring defined in the inner part of the pulleys.

In a research conducted in specialized database documents were found referring to casters, such as, for example, document no. MU 7400823-4 which provides supporting part composed of a body equipped with lateral extension in form of an arc of a circle, which holds another extension, in which disc axles are joined, such that, in the body, the lower half of the pin equipped with a bearing is joined, and in whose upper half externally treaded part is joined.

Another document with no. MU 7301940-2 refers to a caster cube assembled around an axle supported on free ends of a fork that is elastically deformable in a release position, in which it does not interfere with the cube, for a braking position, in which it axially compresses said cube, preventing it from rotating. It is also provided with an articulated lever at the fork to be displaced between an inoperative position of rest, corresponding to the fork's release condition and an operative braking position, in which it interferes with a camsurface portion of said fork, in order to displace the latter to its braking position.

As can be seen, none of these casters, or others checked in the research, forestall the characteristics of this shielded caster model.

### SUMMARY OF THE INVENTION

Thus, contemplating on providing improvements to the consumer market, the applicant developed this invention in shielded hospital caster, which was idealized to be used on hospital furniture and equipment, providing fast displacement and preventing the accumulation of dirt in its interior.

Said shielded hospital caster is produced in nylon 6.0 with impact modifier or other adequate material and, basically, is composed of a structural framework of injected material, where this framework constitutes the main structure of the caster. Said shielded caster is presented in two versions, where one is equipped with a brake and the other with no brake.

For this purpose, the cited structural framework has a casing with lower opening which can accommodate the shielding assembly with brake lever or a single shielding part, without the brake lever.

Both shielded caster versions, with or without brake, receive a rotation assembly that includes a transversal shaft that goes beyond the framework and sustains, at each of its ends, a wheel that, in turn, is cased in its respective lateral flap of the framework. Each wheel has, as finish, a hubcap, for shielding of the central portion of the cited wheel.

The vertical member of the framework is tubular and idealized to contain a solid steel shaft around which a group of washers and a toothed track is mounted. This toothed track is associate with locking teeth executed at the end of the vertical arm of a sliding body in the vertical direction, where this displacement is done through activation or deactivation of a brake lever pedal. Said sliding body also has two identical and symmetrically located lower lateral flaps, which have a plurality of spacing notches and dimension compatible with a toothed circular sector, executed on the inner face of each wheel.

Thus, when the brake lever pedal is at resting position, that is, activated upward, the sliding body is found at the center in relation to the wheel set axle, allowing rolling of the wheels on the floor. Aside from this, the teeth executed at the end of the vertical arm of the sliding body are found far from the toothed track, thus allowing the “crazy” rotation of the caster in the horizontal direction.

When the brake lever pedal is activated, that is, moved downward, the sliding body, through an oblong-shaped hole, can be moved upward in relation to the wheel set axle, causing the locking teeth of the vertical arm to lean on the toothed track teeth, blocking the “crazy” rotation of the caster, at the same time in which the lateral flaps, with the cited notches, are forced to dislocate toward the teeth of the toothed circular sector of the wheels, blocking the rolling movement of the wheels.

The setup of the sliding body, although it presents a vertical displacement and opening of the lateral flaps in relation to the framework, ensures total shielding of the caster, adding the advantage of its locking or release.

In case the caster does not have any brake, the body coupled to the framework does not slide, that is, it acts as cover of the framework's lower part and allows total freedom to the caster from rotating “crazily” and from rolling over the floor, however, it does not allow the entry and/or accumulation of dirt in the internal parts, favoring cleaning and external sanitization.

### BRIEF DESCRIPTION OF THE DRAWINGS

To complement this description in order to obtain a better understanding of the characteristics of this invention and in accordance with its preferential practical realization, the enclosed description comes with a set of drawings, where, in an exemplified fashion, although not limited, the following was represented:

FIG. 1 represents a perspective view of the shielded caster with braking device, idealized as 1st constructive version of this utility model;

FIG. 2 illustrates another constructive version of the shielded caster, however without the braking device;

FIG. 3 shows an exploded perspective view of the shielded hospital caster with brake system;

FIG. 4A illustrates a longitudinal cross section of the caster revealing the framework, the sliding body and the brake lever pedal in resting position, that is, with the vertical arm of the sliding body away from the toothed track, allowing rotation in the horizontal direction (“crazy”) and rolling of the wheels;

FIG. 4B represents a transversal cross section, showing the lever pedal in resting position, which maintains the lateral flaps of the sliding body in a position away from the teeth of the toothed sector of each caster wheel, allowing rolling of the wheels;

FIGS. 5A and 5B illustrate longitudinal and cross section of the caster revealing the framework, the sliding body and the brake lever pedal in locking position, that is, with the vertical arm of the sliding body coupled to the toothed track, blocking rotation in the horizontal direction (“crazy”) and the lateral flaps of the sliding body forcedly open by the lever pedal, causing the teeth of the toothed sector of each caster wheel to be locked by the notches of said flaps, blocking the rolling of the wheels;

FIG. 6 shows a perspective view of the shielded hospital caster without brake;

FIG. 7 represents a lateral view of the shielded hospital caster without brake; and

FIGS. 8A and 8B represent longitudinal and cross section views, respectively, of the shielded hospital caster without brake.

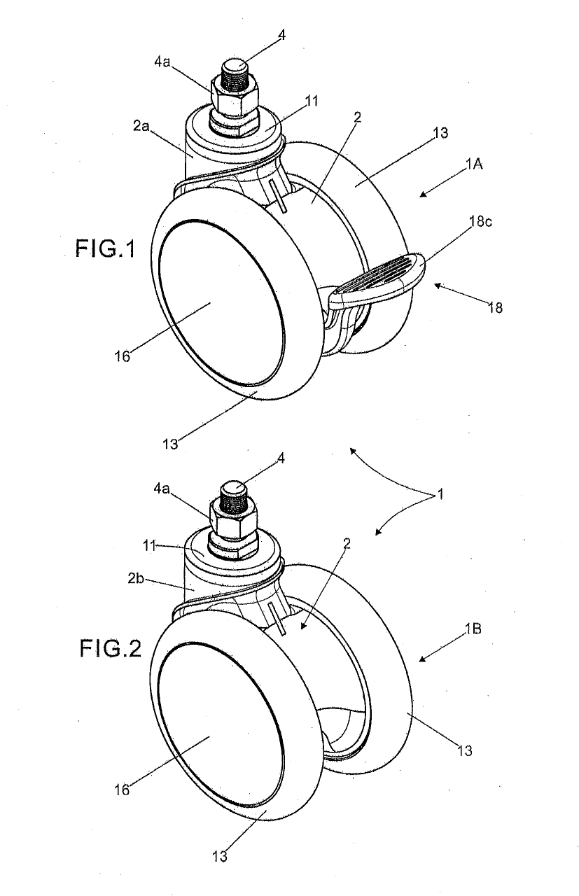

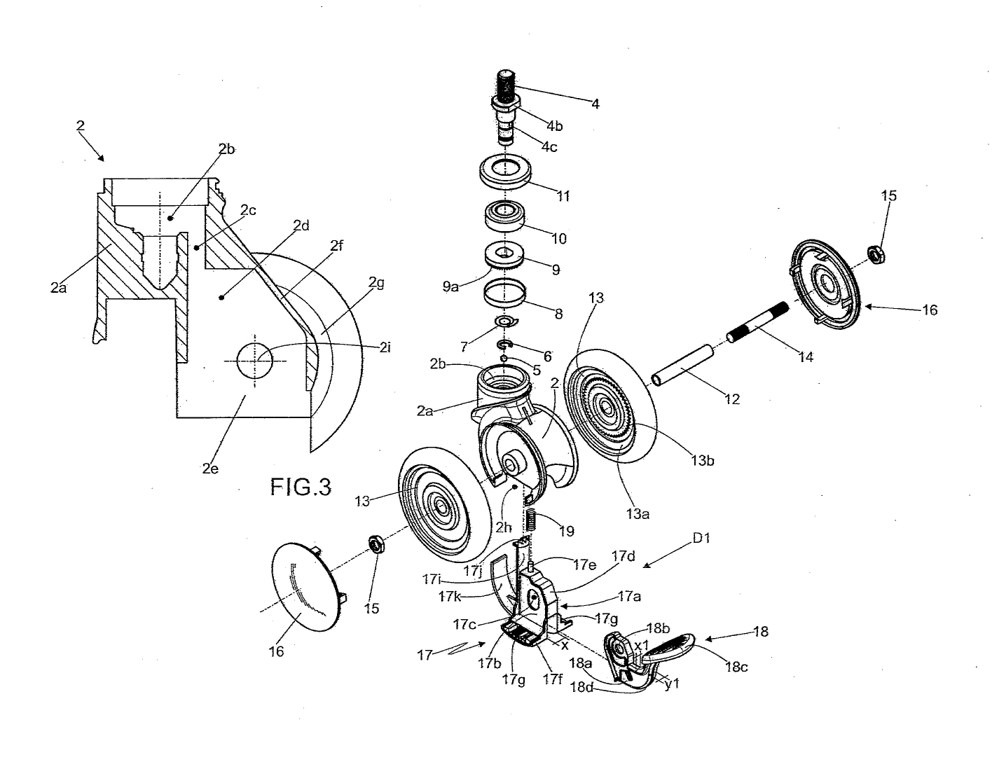

### DETAILED DESCRIPTION OF THE EMBODIMENTS

With references to the illustrated drawings, this invention refers to a shielded hospital caster (1) of the kind used in furniture and equipment in hospitals, clinics, among others, where this furniture are those such as, stretchers, beds, armchairs, closets, tablets, etc.

The shielded hospital caster (1) is produced in nylon 6.0 with impact modifier or other adequate material, and is, basically, composed of structural framework (2) of injected material and is considered, in this invention, the caster's main structure, since it sustains the solid steel axle (4) and respective nut (4a) for assembly in the furniture (not illustrated), aside from rolling axle (12), in which the wheels (13) are mounted which, preferably, adopt the setup described in this same applicant's patent no. PI 0701644-1, that is, set up in solid piece, whose intermediary part (13a) presents gear segments (13b) executed at the side of the wheel that stays facing toward the framework (2). Said wheels are fixed to the framework through nuts (15) and covered, externally, through hubs (16).

According to this invention, the shielded caster (1) is presented in two constructive versions, formed with the same technical shielding characteristics, however, a first version (1A) with brake pedal (18), that is, rotation lock in its own vertical axle (“crazy rotation”) (F1) and block in the rolling direction (F2), another second version (1B) where the caster does not have a brake, that is, it has free rotations.

The cited structural framework (2) presents the same constructive setup to be used both in the (1A) version and in the (1B) version and, for this purpose, it includes a single body, with cylindrical tubular projection (2a) provided in its upper portion of the cylindrical casing (2b) with escalated regions in different diameters, more specifically for mounting of a set of parts that allow the “crazy rotation” of the caster, namely: the solid axle (4), whose lower end overlaps a sphere (5) and includes an O-ring (6) and lock ring (7). Said axle (4) maintains positioned inside the projection (2a), through the diameter widening region (4b), a bearing (10) that is shielded by a sealing cover (11). Under the bearing (10), the axle (4) presents a keyed sector (4c) for setting of an annular track (9), whose lower face is provided with radial teeth (9a), such that said track (9) is surrounded by a ring (8). The cylindrical casing (2b) has a lateral opening in its internal base, which communicates with a longitudinal canal (2c) and this, in turn, communicates with the hollow region (2d) of the framework, conformed by lateral walls (2e), upper front cover (2f) and between the lateral flats (2g) for accommodation of the wheels (13), which are centered on the walls (2e) through accommodation of the rolling axle (12) in orifices (2i). The lower portion of the lateral flaps (2g) is presented interrupted, which comprises a free area (2h).

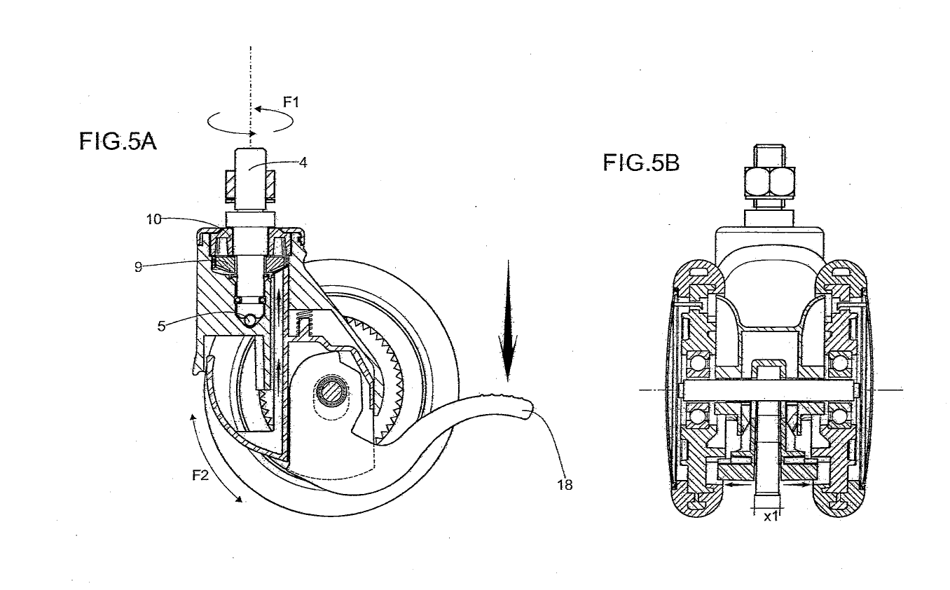

The shielded caster version with brake (1A) provides that the hollow region (2d) of the framework (2) receives the mounting of a device (D1), formed by a moving body (17) activated by the brake pedal (18). Said moving body is constituted by a single part composed of central member (17a) formed by a pair of parallel walls (17b), spaced in (x) and where each of them has an oblong slot (17c) aligned to each other susceptible of accommodating the rolling axle (14). The upper region of the walls is joined by walls (17d) in whose apex is provided with a pin (17e) which anchors the end of helical spring (19), whose other end is anchored on the upper internal wall of the hollow region (2d). The lower portion of the walls (17a) is totally open for the introduction and movement of the brake pedal (18) and present, each of said walls, an external flap (17f), slightly arched upward and provided with teeth or notches (17g). These flaps (17f) are dimensioned to act in the free area (2h) of the flaps (2g) of the framework, in order to interact, at the time of activation of the brake pedal (see FIG. 5A) with the gear segments (13b) of the wheel (13). The lateral region of the walls (17a) is, also, closed by a wall (17i) which is stretched vertically and presents, at its free end, a toothed head (17j) which, at the time of activation of the brake pedal (see FIG. 5A), is coupled on the teeth (9a) of the toothed track (9).

Complementing the shielding offered by the moving body (17) in relation to the framework (2), an arched wall (17k) is provided whose free end lies on the lower edge of the tubular projection (2a), sealing the assembly against dirt.

The brake pedal (18) includes a laminar sector (18a) with central opening (18b) for crossing of the rolling axle (14), where this laminar sector is joined to the pedal (18c), strictly speaking, by a wall (18d) of variable width, that is, close to the laminar sector, presents thickness (x1), equivalent to the thickness (X) between the walls (17b) and, close to the pedal (18c) presents thickness (y1), greater than the thickness (x1).

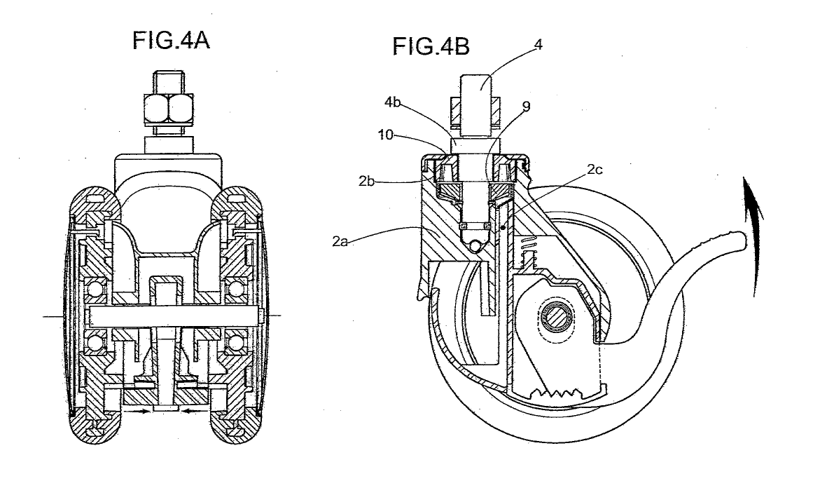

Thus, when the brake pedal (18) is found in resting position, (FIGS. 4A and 4B), the moving part (17) is found displaced downward in relation to the framework, maintaining the head (17j) away from the toothed track (9) and the flaps (17f) with teeth (17g) away from the gear segments (13a) of the wheels (13).

Once the brake pedal (18) is pressed downward (FIGS. 5A and 5B), the moving part is activated upward in relation to the framework (2), where this movement is allowed by the oblong slots (17c) in relation to the axle (14), causing the head (17j) to clamp on the teeth (9a) of the track (9) locking the “crazy” rotation of the caster, at the same time that the thickness (y1) goes in between the walls (17b) forcing them to displace to the sides until clamping of the teeth or notches (17g) occurs in the gear segments (13a) of the wheels (13), locking the rolling of the cited wheels, consequently stopping the caster.

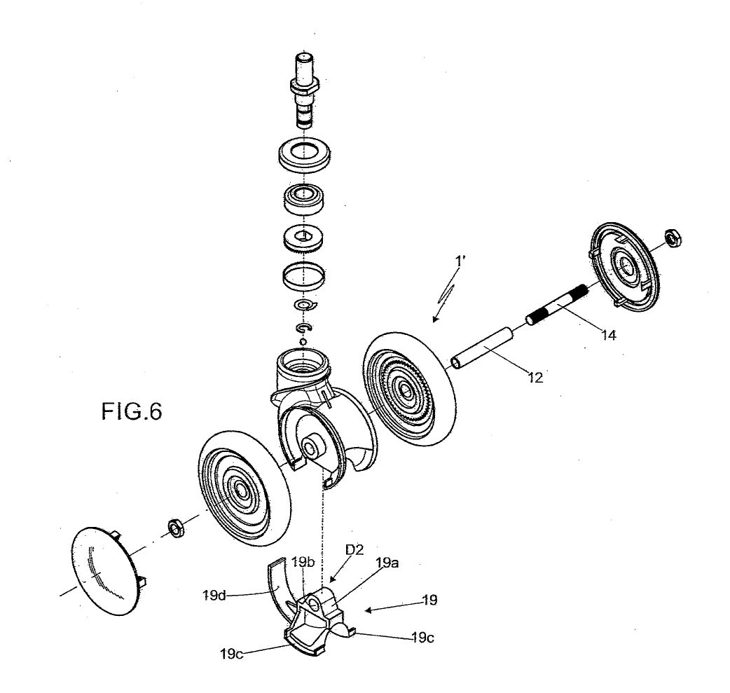

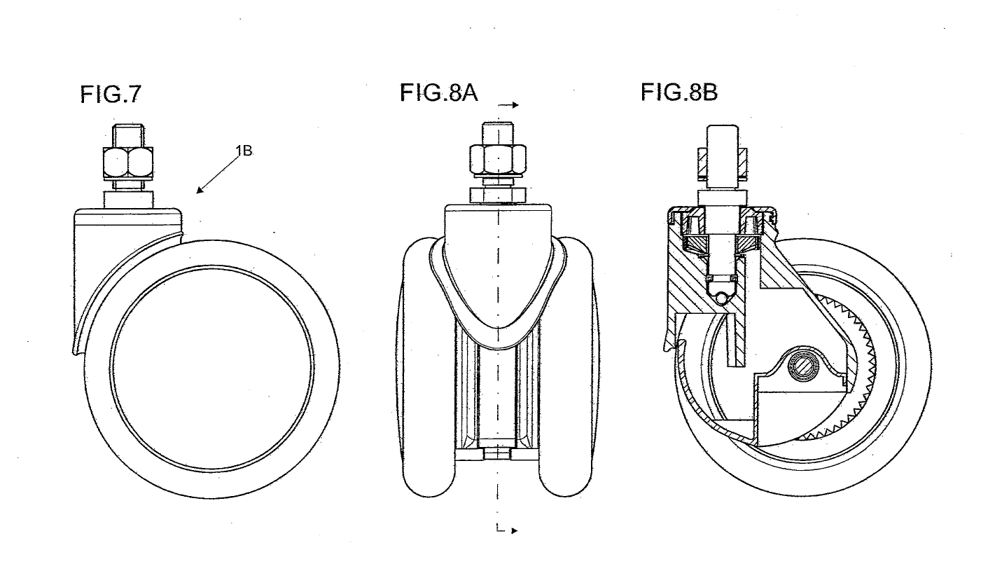

The shielded caster version without brake (1B) (FIGS. 7, 8A and 8B) provides that the hollow region (2d) of the framework (2) receives the mounting of a device (D2) (FIGS. 6, 7, 8A and 8B), formed by a fixed body (19) constituted by a single part composed of a central member (19a) equipped with opening (19b) susceptible of being crossed by the rolling axle (14). From the lower portion of the central member (19a) external flaps (19c) are projected laterally, symmetric and slightly arched upward which are adjusted in the free area (2h) of the flaps (2g) of the framework, sealing them. Complementing the shielding offered by the device (D2), the fixed body (19) includes an arched wall (19d), whose free end lies on the lower edge of the tubular projection (2a), sealing the assembly against dirt.

What is claimed is:

1. A shielded hospital caster for use on furniture and medical equipment, said caster being produced from nylon 6.0 with an impact modifier and comprising:
a framework;
a solid steel axle and a cooperating nut for mounting on furniture, the nut surrounding the axle and the axle being connected to the framework;
a rolling axle rotatably mounted to the framework;
wheels mounted on the rolling axle, said wheels each having an intermediary part forming gear segments on an interior side of the wheel that faces the framework, said wheels being fixed to the rolling axle via nuts and sealed, externally through hubs; and
a device connected to a lower base of the framework and comprised of a moving body configured to be activated by a brake pedal, said device being configured for performing locking or release of rotation on the stainless steel axle, through engagement of a head of the moving body with a toothed track mounted around the solid steel axle, and said device being configured for performing locking or release in a rolling direction by engagement of teeth on lateral flaps of the moving body with the gear segments of the wheels.

2. A shielded hospital caster for use on furniture and medical equipment, said caster being produced from nylon 6.0 with an impact modifier and comprising:
a framework;
a solid steel axle and a cooperating nut for mounting on furniture, the nut surrounding the axle and the axle being connected to the framework;
a rolling axle rotatably mounted to the framework;
wheels mounted on the rolling axle, said wheels each having an intermediary part forming gear segments on an interior side of the wheel that is facing toward the framework, said wheels being fixed to the rolling axle via nuts and sealed, externally through hubs; and
a device connected to a lower base of the framework and forming a fixed body.

3. The caster according to claim 1, wherein the framework comprises a single body, with a cylindrical tubular projection having an upper portion with escalated regions of different diameters, said projection being configured for receiving the solid steel axle, and further comprising:
a sphere abutting a lower end of the solid steel axle,
an O-ring and a lock ring disposed inside the tubular projection for maintaining a position of the solid steel axle within the projection,
a bearing that is shielded by a sealing cover, said bearing and sealing cover being disposed within the projection and surrounding the solid steel axle,
wherein under the bearing, the solid steel axle has a keyed sector for setting of the toothed track, said keyed sector having a lower face with radial teeth, wherein said track is surrounded by a ring,
wherein the framework has a lateral opening at its internal base, which communicates with a longitudinal canal, said canal communicating with a hollow region of the framework, the framework having lateral walls, an upper front cover and lateral flaps for accommodation of the wheels, said wheels being centered on the lateral walls through accommodation of the rolling axle in orifices of the framework; and
wherein lower portion of the lateral flaps is interrupted by a free area.

4. The caster according to claim 3,
wherein the device is received in the hollow region of the framework,
wherein the moving body is formed by a single piece composed of a central member formed by a pair of parallel walls, each with an oblong slot aligned to each other, said slots being configured for accommodating the rolling axle,
wherein an upper region of the parallel walls is joined by a transverse wall and further comprising a pin mounted on an apex of said transverse wall and a helical spring anchored by said pin at one end thereof, the other end of the helical spring being anchored on an upper internal wall of the hollow region,
wherein a lower portion of the parallel walls is totally open for introduction and movement of the brake pedal,
wherein the external flaps are slightly arched upward and provided with teeth or notches, said flaps being dimensioned to act in the free area of the flaps of the framework in order to interact, at a time of activation of the brake pedal with the gear segments of the wheel,
wherein a lateral region of the parallel walls is closed by a wall that is stretched vertically and presents, on a free end, a toothed head that, upon activation of the brake pedal, is coupled with the teeth of the toothed track, and
wherein an arched wall is provided on the device, said arched wall having a free end that lies on the lower edge of the tubular projection.

5. The caster according to claim 4, wherein the brake pedal includes a laminar sector with a central orifice for crossing the rolling axle, said laminar sector being joined to the pedal by a wall of variable width, said wall of variable width having a thickness near the laminar sector that is equivalent to a distance between the parallel walls and having a thickness close to the pedal than is greater than the thickness near the laminar sector.

6. The caster according to claim 2, wherein the framework has a hollow region which receives the device, wherein the device is formed by a single part composed of a central member equipped with an orifice that is crossed by the rolling axle, wherein external flaps projection from a lower portion of the central member, laterally, symmetric and slightly arched upward so that the external flaps are adjusted in a free area between flaps of the framework, sealing them, and wherein the device includes an arched wall having a free end that lies at a lower edge of a tubular projection of the framework, sealing the caster against dirt.
